(19) United States
(12) Patent Application Publication
(10) Pub. No.: US 2007/0105537 A1
(43) Pub. Date: May 10, 2007

(54) Network support for remote caller ID information

(76) Inventors: Sanjeev Mahajan, Naperville, IL (US); Ajay K. Buti, Naperville, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/272,238

(22) Filed: Nov. 10, 2005

(51) Int. Cl. H04M 3/42

(52) U.S. Cl. 455/415

(57) ABSTRACT

An apparatus in one example has: a home terminal and a remote terminal operatively coupled to a call control system in a telecommunication system; a storage operatively coupled to the call control system; caller ID information for a plurality of calls to the home terminal, the caller ID information stored in the storage; and the remote terminal having access to the caller ID information stored in the storage.

### TECHNICAL FIELD

The invention relates generally to telecommunications networks, and more particularly to a telecommunications network that has a caller ID (caller identification) feature.

### BACKGROUND

Wireless and wired communication systems are constantly evolving. System designers are continually developing greater numbers of features for both service providers as well as for the end users. In the area of wireless phone systems, cellular based phone systems have advanced tremendously in recent years. Wireless phone systems are available based on a variety of modulation techniques and are capable of using a number of allocated frequency bands. Available modulation schemes include analog FM and digital modulation schemes using Time Division Multiple Access (TDMA) or Code Division Multiple Access (CDMA). Each scheme has inherent advantages and disadvantages relating to system architecture, frequency reuse, and communications quality. However, the features the manufacturer offers to the service provider and which the service provider offers to the consumer are similar between the different wireless systems.

Regardless of the modulation scheme in use, the wireless phone available to the end user has a number of important features. Nearly all wireless phones incorporate at least a keyboard for entering numbers and text, and a display that allows the user to display text, dialed numbers, pictures and incoming caller numbers. Additionally, wireless phones may incorporate electronic phonebooks, speed dialing, single button voicemail access, and messaging capabilities, such as e-mail.

The features described above present only a sample of features that are capable of, or have already been, implemented into wireless phone systems. Any individual feature is capable of implementation into some or all of the wireless systems using the modulation schemes mentioned above. A particularly useful feature provides caller ID in wireless telecommunication systems, as well as, wired telecommunication systems. Caller ID is a network service feature that permits the recipient of an incoming call to determine, even before answering, the number from which the incoming call is being placed.

Most subscribers now have some form of voice mail system, either a personal answering system or they subscribe to a voice service offered by the service provider. This allows them to find out if anyone called while they were out and if the calling party left them a message. The subscribers may also have caller ID service. A phone at home keeps a history of caller ID information thus allowing the subscribers to find the phone number of a calling party when, for example, it is difficult to decipher the phone number stated in a message or when the caller did not leave a phone number or a message. However, if the subscribers are traveling or picking up messages remotely they are unable to determine the caller ID of a calling party till they get back home.

Thus, there is a need in the art to provide an improved caller ID system wherein the subscriber has access to caller ID information from any location.

### SUMMARY

One implementation encompasses an apparatus. This apparatus may comprise: a home terminal and a remote terminal operatively coupled to a call control system in a telecommunication system; a storage operatively coupled to the call control system; caller ID information for a plurality of calls to the home terminal, the caller ID information stored in the storage; and the remote terminal having access to the caller ID information stored in the storage.

One implementation encompasses a method. This embodiment of the method may comprise: storing caller ID information in a telecommunication system corresponding to a plurality of calls received at a home terminal; and accessing the stored caller ID information from a remote terminal.

### DESCRIPTION OF THE DRAWINGS

Features of exemplary implementations will become apparent from the description, the claims, and the accompanying drawings in which:

FIG. 1 is a representation of one implementation of an apparatus in a telecommunication network that has a caller ID feature;

FIG. 2 is a representation of one implementation of an apparatus in a wireless telecommunication network that has a caller ID feature;

FIG. 3 is a representation of another implementation of an apparatus in a wired telecommunication network that has a caller ID feature;

FIG. 4 is a representation of a further implementation of an apparatus in an Internet telecommunication network that has a caller ID feature; and

FIG. 5 is a representation of one exemplary flow diagram for providing a caller ID feature functionality in a telecommunication network.

### DETAILED DESCRIPTION

Caller ID is an analog service offered by a central office (CO), which supplies calling party information to subscribers. Typically, the calling party number, and sometimes the name, appears on a telecommunication terminal, such as a PC telephony software application screen or the display on a telephone. Type 1 caller ID provides the calling party information while the call is ringing, and Type 2 caller ID provides the additional convenience of calling number display while the recipient is on another call.

Type 1 Caller ID only works when the phones are not in use (ON-HOOK). The telephone company delivers a signal (tone) between the first and second ring of an incoming call. This signal contains the Caller ID information packet.

This packet comes in two forms, the older Single Data Message Format (SDMF) and the Multiple Data Message Format (MDMF). The Single provides only the time, date, and the phone number of the call. Whereas, the Multiple Data Message Format also includes the name of the caller. Both of these messages are displayed on the CID box or modem, if they are so equipped. When using a modem, the associated PC must be powered on and software enabled unless the modem is stand-alone and has storage.

Type 2 Caller ID works the same as Standard Caller ID, but it also works when the phone line is being used (OFF-HOOK). In this case, the telephone company produces two signals. The first is the audible Call Waiting Tone to alert the person on the phone that someone is calling. This is the same tone that is used with the basic Call Waiting Service. The second is the Caller ID Query otherwise known as the CPE Alerting Signal (CAS). This is a machine tone that only the Caller ID box recognizes.

In one known system the caller ID is transmitted as a data parameter in the SS7 Initial Address Message from the originating end switch to the destination end switch in the process of setting up the call. Some caller ID services can also provide directory name listing information, derived separately from the LIDB data base. Caller ID information is typically transferred as a type-202-modem-compatible data signal between the first two ringing cadence cycles of the alerting tone.

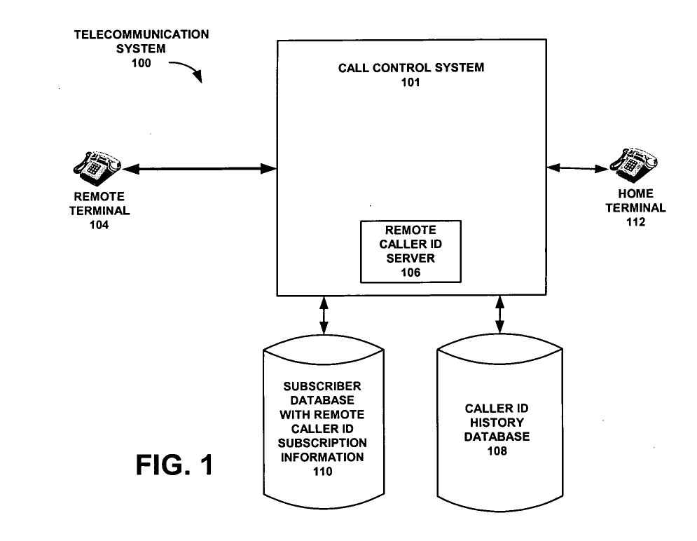

FIG. 1 depicts a telecommunication system 100. In the system 100 a remote caller terminal 104 and a home terminal 112 are operatively coupled to a call control system 101. The call control system 101 may also have a remote caller ID server 106 that interfaces the call control system 101 to databases 108 and 110. Database 110 is a subscriber database that contains information regarding subscribers and features of the telecommunication system to which they subscribe, in particular a remote caller ID feature. Database 108 is a caller ID history database that contains caller ID information for calls that arrive at the home terminal 112. The remote caller ID server 106 stores or retrieves information in these databases 108, 110 in response to instructions from the call control system 101. In particular, the remote caller ID server 106 allows access to the caller ID information in the database 108 by the validated remote terminal 104.

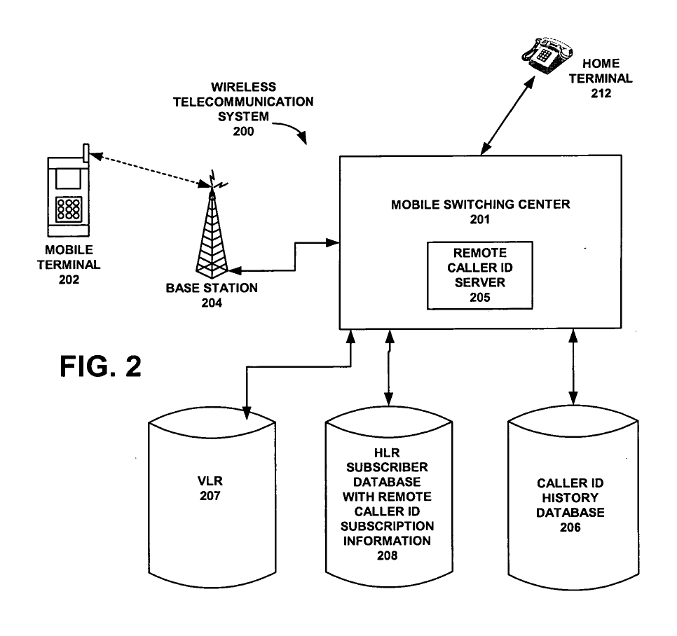

FIG. 2 depicts a wireless communication system 200. In the system 200 a remote mobile terminal 202 may be operatively coupled to a mobile switching center (MSC) 201. The MSC 201 has a relatively complex task, as unlike a conventional telephone exchange, when subscribers make calls they could be anywhere within the network. The MSC 201 must ensure that calls are routed through to those subscribers, wherever they are and wherever they move to throughout the duration of each cell.

In order to simplify the subscriber management function, a specific service area is allocated to each MSC 201. The MSC 201 has to control the switching of tariff to and from the subscribers within it's service area which involves the coordination of all radio resources and the inter cell hand-off activities.

A Home Location Register (HLR) 208 may be the central database for all the subscribers which contains details on the identity of each subscriber, the services to which they have access and the locations where the subscriber was last registered. All subscriber administration procedures are communicated to the HLR 208 where the data is stored until it is required by another part of the network.

The Visitor's Location Register (VLR) 207 is a database that is linked to MSC 201 and temporarily stares information about each mobile terminal 202 within the area served by that MSC 201. The information that is temporarily stored in the VLR 207 is sufficient to allow any mobile station 202 within that MSC 201 area to make and receive calls. This includes the mobile station's identity, the area in which it was last registered and data pertaining to the subscriber and any supplementary services that have been selected by the subscriber. The MSC 201 refers to the VLR 207 each time that a mobile terminal 202 attempts to make a call in order to verify that the request can be fulfilled. This process is to establish that no call restrictions or call barring instructions are in place.

A storage, such as caller ID history database 206, is operatively coupled to the MSC 201. A caller ID history database 206 may contain caller ID information for a predetermined number of calls that were received by a home terminal 212. The caller ID information may be stored in and retrieved from the caller ID history database 206 under control of a remote caller ID module 205 in the mobile switching center 201. The remote caller ID server 205 stores or retrieves information in the database 206 in response to instructions from the MSC 201. The remote caller ID server 205 may be implemented in software, hardware, or a combination of hardware and software. When the MSC terminates a call to the mobile it checks if the mobile subscriber also subscribes to the “Remote Caller ID” feature. If the call is for a “Remote Caller ID” feature subscriber then the MSC informs the remote caller ID server 205 to store the Caller ID information in the Caller ID History Database 206. At a later time the “Remote Caller ID” feature subscriber can call into the remote caller ID server 205 to retrieve the caller ID information, in a manner similar to the voice mail systems.

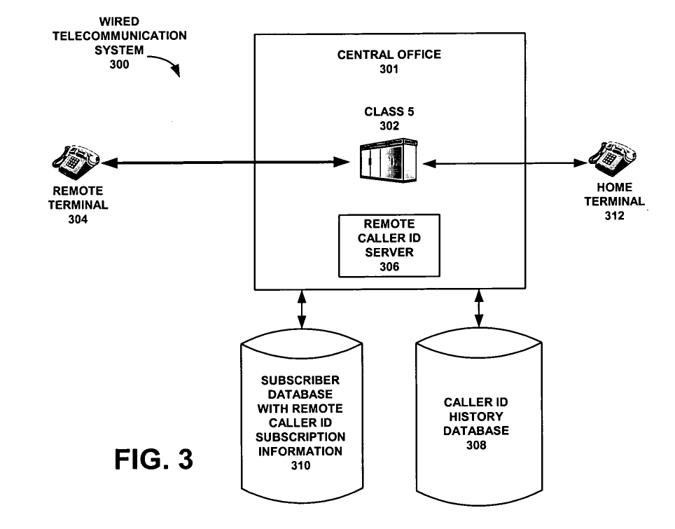

FIG. 3 depicts a wired communication system 300. In the system 300 a remote caller terminal 304 and a home terminal 312 may be operatively coupled to a central office (CO) 301. In telephone communication in the United States, a CO 301 is an office in a locality to which subscriber home and business lines are connected on what is called a local loop. The CO 301 has switching equipment 302 that can switch calls locally or to long-distance carrier phone offices. The CO 301 may have a class 5 switch 302. Class 5 is a classification of a switching system that is used by local telephone service providers. A class 5 switch is the last point in the network prior to the customer.

A storage, such as caller ID history database 308, may be operatively coupled to the CO 301 through the Remote Caller ID Server 306. Caller ID information may be stored in and retrieved from the caller ID history database 308 under control of a remote caller ID server 306 in the CO 301. The remote caller ID server 306 stores information in database 308 in response to instructions from the CO 301. The caller ID history database 308 may contain a predetermined number of previous calls up to a set maximum number that were received by the home terminal 312. The remote caller ID server 306 may be implemented in software, hardware, or a combination of hardware and software. When the CO 301 terminates a Call to the Home Terminal 312 it checks if the subscriber also subscribes to the “Remote Caller ID” feature. If the call is for a “Remote Caller ID” feature subscriber then the CO 301 informs the remote caller ID server 306 to store the Caller ID information in the Caller ID History Database 308 and provides it the Caller ID information. At a later time the “Remote Caller ID” feature subscriber can call into the remote caller ID server 306 to retrieve the caller ID information, in a manner similar to the voice mail systems. When the subscriber calls into the remote caller ID server 306, the server 306 authenticates the caller by requiring then to enter a password. After the subscriber successfully authenticates himself or herself the remote caller ID server 306 allows them to retrieve the caller ID history from Caller ID History database 308 using voice prompts.

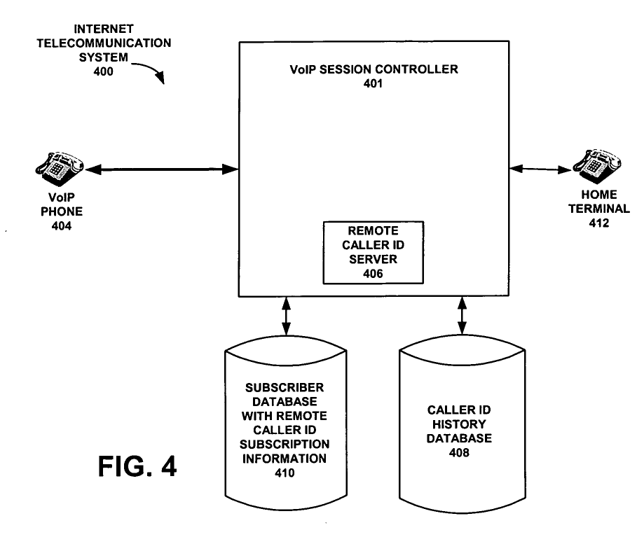

FIG. 4 depicts an Internet communication system 400. In the system 400 a remote caller terminal 404 and a home terminal 412 may be operatively coupled to a VoIP (voice over Internet protocol) session controller 401. VoIP is the transmission of a telephone call over the Internet. The Internet sends small packets of data over a network by packet switching. At the source, a large amount of data is split it up into many packets. Each packet is given an address that tells the network where to route each packet. At the destination, the packets are reassembled into the original data. Packet switching is very efficient because it minimizes the amount of time that a connection must be maintained between two sources and thus reduces the load on a network.

A storage, such as caller ID history database 408, may be operatively coupled to the VoIP session controller 401 through the Remote Caller ID server 406. Caller ID information may be stored in and retrieved from the caller ID history database 408 under control of a remote caller ID server 406 in the VoIP session controller 401. The remote caller ID server 406 stores information in the database 408 in response to instructions from the VoIP session controller 401. The caller ID history database 408 may contain a predetermined number of previous calls, which were received by the home terminal 412, up to a set maximum number. The remote caller ID server 406 may be implemented in software, hardware, or a combination of hardware and software. When the VoIP session controller 401 terminates a Call to the Home Terminal 412 it checks if the subscriber also subscribes to the “Remote Caller ID” feature. If the call is for a “Remote Caller ID” feature subscriber then the VoIP session controller 401 informs the remote caller ID server 406 to store the Caller ID information in the Caller ID History Database 408 and provides it the Caller ID information. At a later time the “Remote Caller ID” feature subscriber can call into the remote caller ID server 406 to retrieve the caller ID information, in a manner similar to the voice mail systems. When the subscriber calls into the remote caller ID server 406, the server 406 authenticates the caller by requiring then to enter a password. After the subscriber successfully authenticates himself or herself the remote caller ID server 406 allows them to retrieve the caller ID history from Caller ID History database 408 using voice prompts.

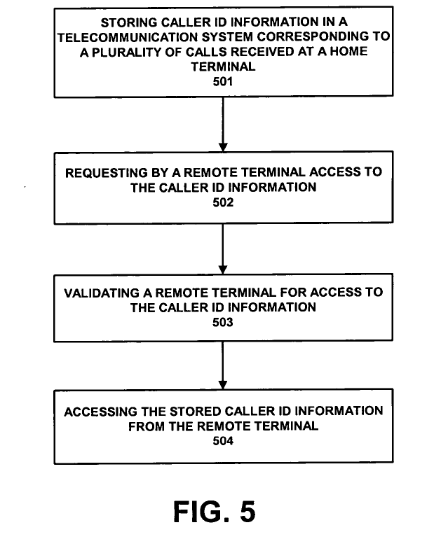

FIG. 5 is a representation of one exemplary flow diagram for providing a caller ID feature functionality in a telecommunication network. This embodiment of the present method comprises: storing caller ID information in a telecommunication system corresponding to a plurality of calls received at a home terminal (501); requesting by a remote terminal access to the stored caller ID information (502); validating the remote terminal for access to the caller ID information stored in the storage (503); and accessing the stored caller ID information from a remote terminal (504). For a wireless network the call control system may be a mobile switching center having a remote caller ID server, for a wireline network the call control system may be a central office having remote caller ID server, and for the Internet the call control system may be a VoIP Session Controller having a remote caller ID server. The caller from the remote terminal may be validated for access to the caller ID information stored in the storage by a validation module in the remote caller ID server, and the caller ID information may be stored in a database.

Thus, embodiments of the present method and apparatus store caller ID information for subscribers of, for example, a remote caller ID feature provided by a service provider. This remote caller ID feature allows the subscribers to retrieve the caller information ID remotely from the storage. Embodiments of the present method and apparatus may also include the feature that the subscriber may specify the maximum number calls that are stored in the caller ID history database. Also, in the various embodiments the remote terminal may be one of a personal computer, a subscriber telephone, a pay telephone, a VoIP phone, or a mobile terminal, and the home terminal may be one of a personal computer, a subscriber telephone, a pay telephone, a VoIP phone, or a mobile terminal.

The present apparatus in one example may comprise a plurality of components such as one or more of electronic components, hardware components, and computer software components. A number of such components may be combined or divided in the apparatus.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. A system, comprising:
a home terminal and a remote terminal operatively coupled to a call control system in a telecommunication system;
a storage operatively coupled to the call control system;
caller ID information for a plurality of calls to the home terminal, the caller ID information stored in the storage; and
the remote terminal having access to the caller ID information stored in the storage.

2. The system according to claim 1, wherein the remote terminal is one of a personal computer, a subscriber telephone, a pay telephone, a VoIP phone, or a mobile terminal, and wherein the home terminal is one of a personal computer, a subscriber telephone, a pay telephone, a VoIP phone, or a mobile terminal.

3. The system according to claim 1, wherein the telecommunication system comprises at least one of a wired network, the Internet or a wireless network.

4. The system according to claim 1, wherein for a wireless network the call control system is a mobile switching center having a remote caller ID module, wherein for a wireless network the call control system is a central office having remote caller ID server, and wherein for the Internet the call control system is a VoIP Session Controller having a remote caller ID server.

5. The system according to claim 4, wherein the call control system has a validation module for validating that the remote terminal is to have access to the caller ID information stored in the storage.

6. The system according to claim 1, wherein the storage is a database.

7. A system, comprising:
a home terminal and a mobile terminal operatively coupled to a mobile switching center in a wireless telecommunication system;
a caller history ID database operatively coupled to the mobile switching center;
caller ID information for a plurality of calls to the home terminal, the caller ID information stored in the caller history ID database; and
the mobile terminal having access to the caller ID information stored in the caller history ID database.

8. The system according to claim 7, wherein the mobile switching center stores validation information which determines if the mobile terminal has access to the caller ID information stored in the caller history ID database.

9. The system according to claim 7, wherein the caller history ID database stores caller ID information for a plurality of calls up to a predetermined maximum number of calls.

10. The system according to claim 7, wherein the mobile switching center has a remote caller ID module for controlling storage of caller ID information in and retrieval of caller ID information from the caller history ID database in response to instructions from the mobile switching center.

11. A system, comprising:
a home terminal and a remote terminal operatively coupled to a central office in a wired telecommunication system;
a caller history ID database operatively coupled to the central office;
caller ID information for a plurality of calls to the home terminal, the caller ID information stored in the caller history ID database; and
the remote terminal having access to the caller ID information stored in the caller history ID database.

12. The system according to claim 11, wherein the central office stores validation information which determines if the remote terminal has access to the caller ID information stored in the caller history ID database.

13. The system according to claim 11, wherein the caller history ID database stores caller ID information for a plurality of calls up to a predetermined maximum number of calls.

14. The system according to claim 11, wherein the central office has a remote caller ID server for controlling storage of caller ID information in and retrieval of caller ID information from the caller history ID database in response to instructions from the central office.

15. A system, comprising:
a home terminal and a remote terminal operatively coupled to a VoIP session controller in an Internet telecommunication system;
a caller history ID database operatively coupled to the VoIP session controller;
caller ID information for a plurality of calls to the home terminal, the caller ID information stored in the caller history ID database; and
the remote terminal having access to the caller ID information stored in the caller history ID database.

16. The system according to claim 15, wherein the VoIP session controller stores validation information which determines if the remote terminal has access to the caller ID information stored in the caller history ID database.

17. The system according to claim 15, wherein the caller history ID database stores caller ID information for a plurality of calls up to a predetermined maximum number of calls.

18. The system according to claim 15, wherein the VoIP session controller has a remote caller ID server for controlling storage of caller ID information in and retrieval of caller ID information from the caller history ID database in response to instructions from the VoIP session controller.

19. A method, comprising:
storing caller ID information in a telecommunication system corresponding to a plurality of calls received at a home terminal; and
accessing the stored caller ID information from a remote terminal.

20. The method according to claim 19, wherein the remote terminal is one of a personal computer, a subscriber telephone, a pay telephone, a VoIP phone, or a mobile terminal, and wherein the home terminal is one of a personal computer, a subscriber telephone, a pay telephone, a VoIP phone, or a mobile terminal.

21. The method according to claim 19, wherein a call control system routes calls from and to each of the home terminal and remote terminal, and wherein the telecommunication system comprises at least one of a wired network, the Internet or a wireless network.

22. The method according to claim 21, wherein for a wireless network the call control system is a mobile switching center having a remote caller ID module, wherein for a wireless network the call control system is a central office having remote caller ID server, and wherein for the Internet the call control system is a VoIP Session Controller having a remote caller ID server.

23. The method according to claim 19, wherein the remote terminal is validated for access to the caller ID information stored in the storage by a validation module in the call control system.

24. The method according to claim 19, wherein the caller ID information is stored in a database.
